(19) United States
(12) Patent Application Publication
(10) Pub. No.: US 2026/0013484 A1
(43) Pub. Date: Jan. 15, 2026

(54) LOBSTER TRAPS AND RELATED METHODS

(71) Applicant: CLEARWATER SEAFOODS LIMITED PARTNERSHIP, Bedford (CA)

(72) Inventors: Keith G. Lohnes, Lunenburg (CA); Ryan J. Mahoney, Pleasantville (CA)

(21) Appl. No.: 18/771,470

(22) Filed: Jul. 12, 2024

(51) Int. Cl. A01K 69/08

(52) U.S. Cl. CPC A01K 69/08

(57) ABSTRACT

A lobster trap includes a top, a bottom, and sides coupled together to form a rectangular enclosure. The sides include an entrance side, an escape side, and a harvest side. The entrance side includes an entrance that extends and narrows inwardly into the rectangular enclosure to permit entry of lobster into the rectangular enclosure. The escape side includes an escape vent to allow lobster smaller than a minimum size to escape the rectangular enclosure. The harvest side includes a flexible mesh and a drawstring. The drawstring is releasable to expand an opening defined by the flexible mesh and is retractable to tighten the drawstring and constrict the opening. Related methods are also disclosed.

### FIELD

The present disclosure relates generally to seafood harvesting, and in particular to harvesting lobster.

### BACKGROUND

Various types of traps are currently used in harvesting lobster. Some crab pots, for example, have a partial conical (or frustoconical) shape, and are designed for entry of crabs at the top of the pot and unloading through a flexible netting at the bottom of the pot. Larger commercial crab traps of rectangular shape that provide for emptying the catch through an opening door are also currently in use.

Traditional lobster pots or traps are designed to catch just a few lobsters. The catch is removed manually, and generally one at a time, through a hinged door that is located at the top of the pot. Rectangular lobster traps are also common in larger-scale harvesting, but manual catch unloading through access openings with hinged doors remains a manual and time-consuming process.

### SUMMARY

According to one aspect of the present disclosure, a lobster trap includes a top, a bottom, and sides coupled together to form a rectangular enclosure. The sides include an entrance side, an escape side, and a harvest side. The entrance side includes an entrance that extends and narrows inwardly into the rectangular enclosure to permit entry of lobster into the rectangular enclosure. The escape side includes an escape vent to allow lobster smaller than a minimum size to escape the rectangular enclosure. The harvest side includes a flexible mesh and a drawstring. The drawstring is releasable to expand an opening defined by the flexible mesh and is retractable to tighten the drawstring and constrict the opening.

A method for harvesting lobster is also provided, and involves hoisting a lobster trap from water and suspending the lobster trap. The lobster trap includes a top, a bottom, and sides, and the sides include an entrance side, an escape side, and a harvest side as described above. The suspending involves suspending the lobster trap with the harvest side oriented downward, and such a method may also involve releasing the drawstring to expand the opening and allow lobster inside the lobster trap to fall out of the lobster trap through the opening, and retracting the drawstring to constrict the opening.

Another aspect of the present disclosure relates to a method of manufacturing a lobster trap. Such a method may involve providing a top, a bottom, and sides, and coupling the top, the bottom, and the sides to form a rectangular enclosure. As in other embodiments, the sides include an entrance side, an escape side, and a harvest side as described above.

Other aspects and features of embodiments of the present disclosure will be or may become apparent upon review of the following description.

### BRIEF DESCRIPTION OF THE DRAWINGS

Embodiments will be described, by way of example only, with reference to the accompanying figures.

FIG. 1 is an isometric view of a lobster trap according to an embodiment, from a top, right, and front perspective.

FIG. 2 is an isometric view of the lobster trap of FIG. 1, from a top, left, and front perspective.

FIG. 3 is a plan view of a front side of the lobster trap of FIG. 1.

FIG. 4 is a plan view of a rear side of the lobster trap of FIG. 1.

FIG. 5 is a plan view of a left side of the lobster trap of FIG. 1.

FIG. 6 is a plan view of a right side of the lobster trap of FIG. 1.

FIG. 7 is a plan view of a top of the lobster trap of FIG. 1.

FIG. 8 is a plan view of a bottom of the lobster trap of FIG. 1.

FIG. 9 is a plan view of a left side of the lobster trap of FIG. 1, with an opening expanded.

FIG. 10 is a perspective view illustrating tapered walls inside the lobster trap of FIG. 1.

FIGS. 11A-D are plan views of tapered walls according to an embodiment.

FIG. 12 is a perspective view illustrating doors of the top of the lobster trap of FIG. 1 in open positions.

FIG. 13 is a plan view illustrating a pattern of flexible mesh that may be used in an embodiment to define an opening at the left side of the lobster trap of FIG. 1.

FIG. 14 is a plan view illustrating a seam to couple ends of the flexible mesh in FIG. 15 together to complete the opening.

FIG. 15 illustrates the lobster trap of FIG. 1 in a suspended position.

FIG. 16 illustrates an example method according to an embodiment.

FIG. 17 illustrates an example method according to another embodiment.

### DETAILED DESCRIPTION

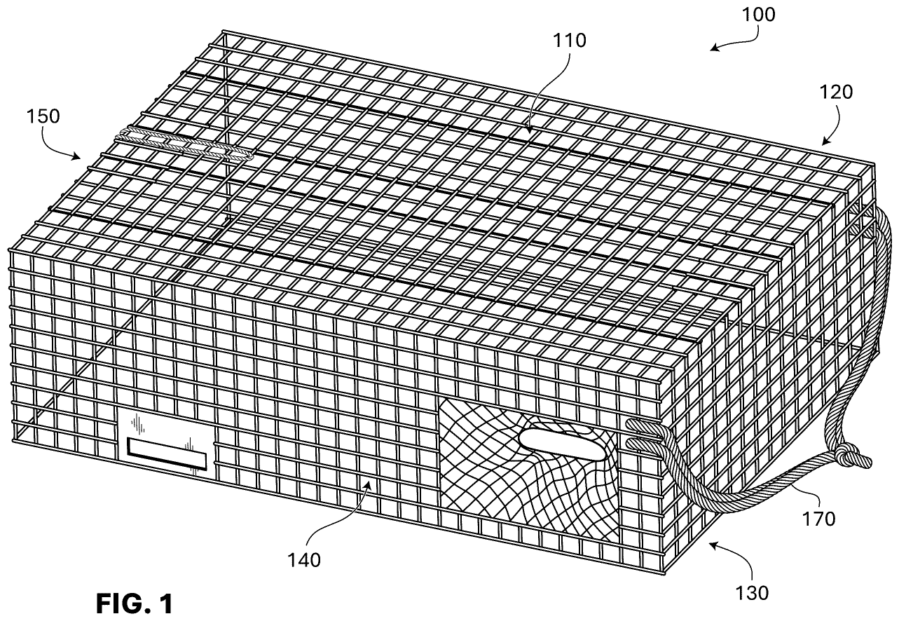

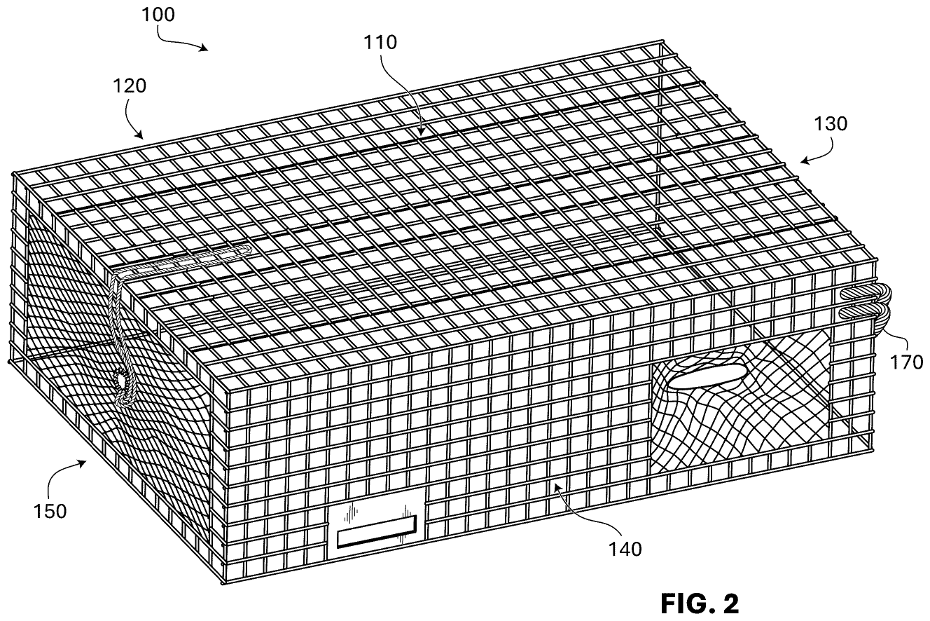

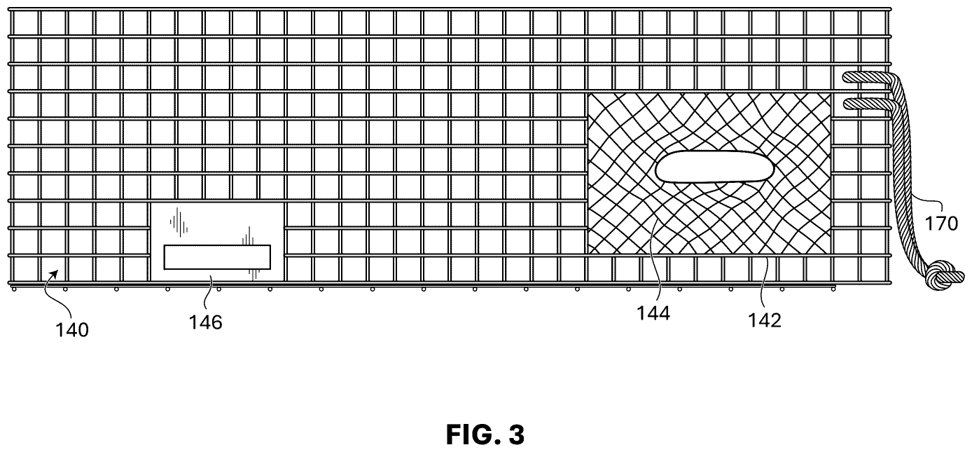

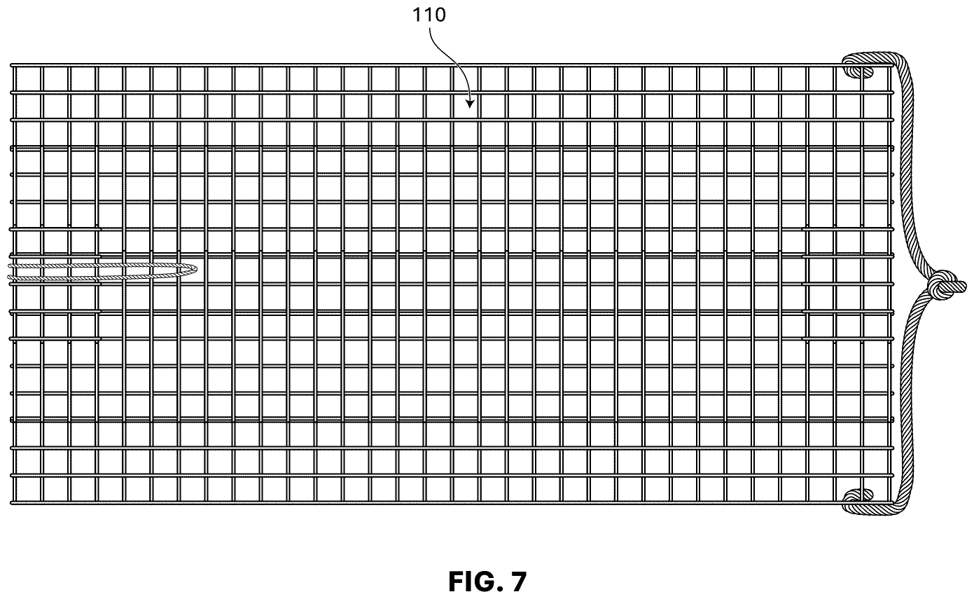

Various views of an example lobster trap 100 and parts thereof are shown in FIGS. 1 to 12. Several drawings provide overall views of the entire example lobster trap, whereas others provide views of only parts thereof. A lobster trap may be made primarily from materials that have an open structure, such as square mesh, to help reduce drag of the trap when it is being hauled up from the seafloor or being set from a vessel to the seafloor. As such, providing complete views of the entire lobster trap in every drawing may obscure features of each part, with other parts being visible through mesh materials. For this reason, in an effort to avoid further congestion in the drawings, FIGS. 1 and 2 provide isometric views in which features of multiple visible sides of the example lobster trap 100 are shown, for example, whereas other drawings such as FIGS. 3 to 9 provide a view of a particular respective side of the example lobster trap.

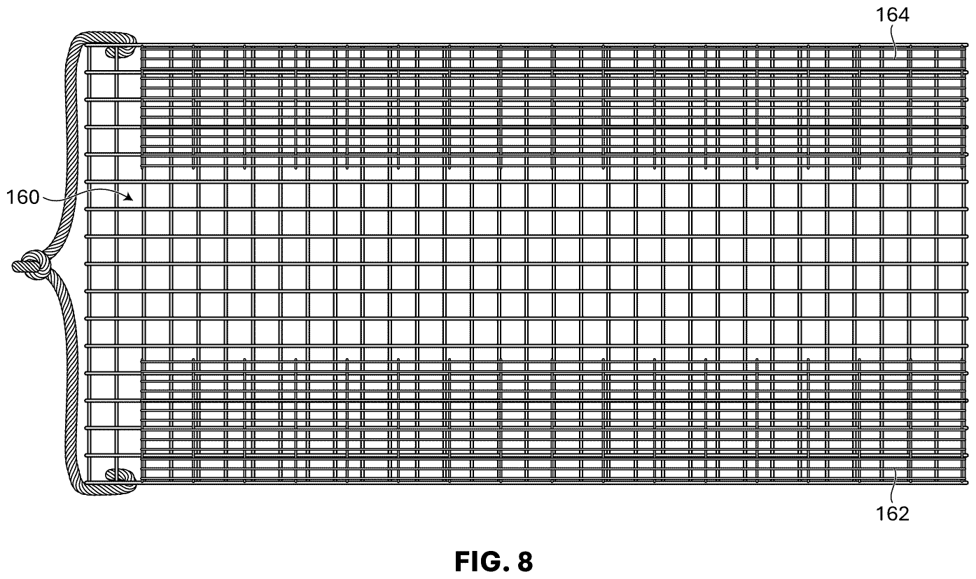

As shown perhaps most clearly in FIGS. 1 and 2, a lobster trap 100 may include pairs of opposite, opposed, or opposing walls that are coupled together to form a rectangular enclosure inside the trap. The walls in the example shown include a top 110, sides 120, 130, 140, and 150, and a bottom 160 (not labelled in FIGS. 1 and 2 but opposite the top 110 and shown most clearly in FIG. 8). These structural parts or pieces that form the rectangular enclosure may be generally referred to as walls, but are also referred to as a top, a bottom, and sides herein, solely for ease of reference. These particular names for the walls are consistent with the orientation shown in FIGS. 1 and 2, which is also consistent with a preferred orientation of the example trap 100 when deployed underwater to catch lobster. It should be appreciated, however, that names and other descriptors herein such as front, rear, left, and right, are illustrative examples only. The structural elements that form a rectangular enclosure inside a trap may be referred to in other ways, herein and/or elsewhere.

Each wall of a rectangular trap such as the example lobster trap 100 is coupled to four other walls. Each wall of a pair of opposed walls is coupled to the same four other walls. These four other walls include two pairs of opposed walls. In the context of any one wall, the four other walls to which that one wall are coupled may be referred to as adjacent walls or coupled walls, for example.

The walls of a lobster trap may be made from any of a number of different materials. Different walls may be made from the same material or different materials, and different walls may include similar or different features, as described in further detail at least below. In the example lobster trap 100, the side wall 130 and the bottom wall 160 are made from a continuous square grid material, but other walls may include other features, and potentially other materials.

A coated wire mesh, such as plastic-coated steel or rubber-coated steel, is an example of a commercially available square grid material that may be used in lobster traps such as the example lobster trap 100. Such material may be available in various sizes. A material and size may be selected for a lobster trap may be selected based on any of various criteria, such as any one or more of the following: cost, availability, strength, weight, resistance to rusting, ease of forming or cutting to size and/or shape, or how walls may be coupled together.

Embodiments disclosed herein are not in any way restricted to coupling components together in a particular way. For example, in the case of a square grid material as shown, deformable coupling elements such as metal clips may be convenient for coupling walls together. So-called “J-clips” are an example of such coupling elements, and are commonly used in constructing lobster traps. Other types of coupling elements include split rings, so-called “hog rings”, wire or plastic ties, zip ties, and materials such as wires, strings, cords, cables, or ropes, which can be tied to couple components together. These and/or other types of mechanical fasteners, such as brackets, may be used to couple components to each other.

Components need not necessarily be coupled together using mechanical fasteners. Wire mesh material may be bent, using a break for example, or otherwise deformed so that multiple walls are formed from a continuous piece of material. This is one example of how components may be integrated with each other and coupled together in this way, without separate coupling elements. The walls of lobster trap could potentially be formed from a single piece of wire mesh material or other deformable material, by cutting or otherwise providing a blank of a particular shape that is deformable to define a rectangular enclosure. A blank in the shape of a “cross”, for example, is deformable to define a rectangular enclosure, in which case each wall is integrated with at least other wall.

Welding to form welded connections and bonding by adhesive to form bonded connections are further examples of how walls may be coupled together without using separate coupling elements.

Coupling may also be referred to as connecting, fastening, attaching, or securing, for example, and accordingly components such as walls may be referred to as being coupled, connected, fastened, attached, or secured. Other terms may also be used, and are intended to be captured herein by references to coupled or coupling.

The examples in respect of coupling are not limited to trap walls, and may also apply to coupling other components, including coupling trap walls and other components together.

In some embodiments, walls of a rectangular lobster trap may be substantially planar, where walls are coupled together at their edges for example. In other embodiments, one or more walls may further extend from a planar section in a different direction. For example, with reference to FIG. 1, the top 110 may extend downwardly to partially overlap the rear side 130 and the front side 140. Similarly, the rear side 120 may extend toward the front and/or the front side 140 may extend toward the rear to partially overlap a planar base section of the top 110 and/or the bottom 160. Other walls may also or instead extend to partially overlap one or more adjacent walls. Such partial overlap may help provide additional strength to particular parts of a trap. Overlapping walls may be coupled together at one or more locations within an overlap region in which the walls overlap. For example, wire mesh material may be bent when made up in sections or pieces using a break, and then coupled together to form a trap.

The foregoing description introduces features related to a basic lobster trap structure with walls, referred to below for ease of reference as a top, a bottom, and sides, coupled together to form a rectangular enclosure.

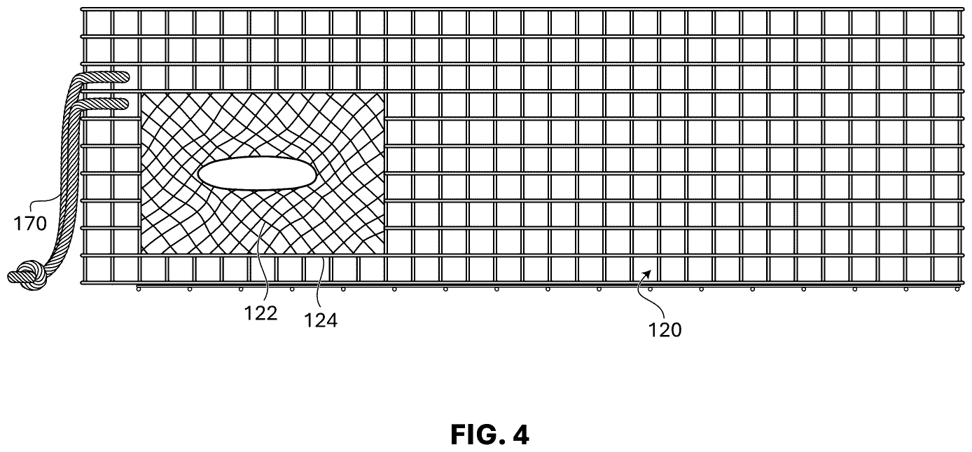

The sides include at least an entrance side through which lobster are able to enter the trap. As shown in FIGS. 3 and 4, respectively, the example lobster trap 100 includes two entrance sides, 140 and 120. An entrance side includes an entrance that extends and narrows inwardly into the rectangular enclosure to permit entry of lobster into the rectangular enclosure. In the examples shown in FIGS. 3 and 4, the entrance 144, 124 extends inwardly into the rectangular enclosure from an opening 142, 122 in each entrance side 140, 120, and narrows inwardly into the rectangular enclosure. This type of entrance may also be referred to as an entrance head, an entry, or a gate, for example, and allows lobster to enter the rectangular enclosure but impedes their ability to exit the enclosure.

An entrance may be made from a flexible material such as fishing net or mesh, with a more rigid inner opening ring or frame (oval in the examples shown) such as a coated metal wire. In such embodiments, an anchor element such as a string or cord, including covered elastic cord that is commonly referred to as “bungee” cord for example, may be coupled to the entrance, to the opening ring or the entrance mesh for example, to maintain inward extension of the entrance into the rectangular enclosure. In the example lobster trap 100, the entrances 120, 140 are opposite each other, and an anchor element may couple the opening rings to each other to maintain them in preferred orientation. In other embodiments, an entrance or a part thereof such as an opening ring may be coupled to a wall or another part of a trap in the preferred direction of extension of the entrance.

An entrance may be made from a rigid material that holds its shape without an anchor element in other embodiments. An entrance that is made from plastic or a coated metal grid or other coated metal material, for example, may be coupled to and held in position by a wall of the trap without using an anchor element. For example, an entrance could be made from a coated metal grid material that is the same as, or similar to (with smaller grid openings for instance), the grid material from which walls of a lobster trap are made.

The sides of a trap may also include an escape side. The front side 140 provides an example of an escape side that includes an escape vent 146 (FIG. 3) to allow lobster smaller than a minimum size to escape the rectangular enclosure. As shown in FIG. 4, an opening is defined in the escape vent 146. Dimensions of the opening are determined according to a minimum size of lobster that may be harvested, which is regulated by fishing authorities and may vary for different fishing grounds.

Although the front side 140 provides an example of an embodiment in which the entrance side and the escape side are the same side, including both an entrance 144 and an escape vent 146, an entrance side need not necessarily also be an escape side (the rear side 120 is an example of an entrance side that is not also an escape side), and similarly an escape side need not also be an entrance side.

Manually unloading catch from a lobster trap takes time, and delays other operations such as storing, resetting, or otherwise handling a trap. Operating a fishing vessel is quite costly, and it is critical to reduce such delays. In the case of a lobster trap, reducing unloading time so that a trap can be reset faster is also important from a production and revenue perspective, in that a trap may be contributing to revenue by trapping lobster only when it is deployed underwater.

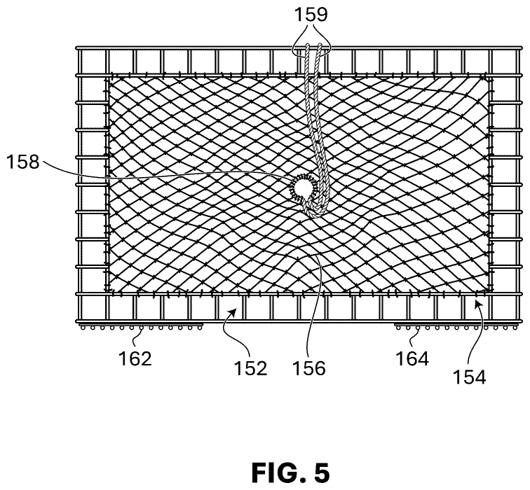

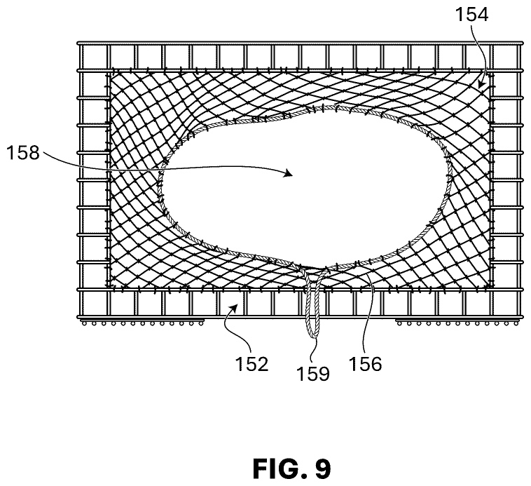

According to conventional techniques, catch is manually unloaded through doors in the top of a rectangular trap. In embodiments herein, however, the sides of a lobster trap include a harvest side that has a flexible and releasable closure. An example of such a closure is shown most clearly in FIGS. 5 and 9. In the example shown, the left side 150 is a harvest side, and includes a flexible mesh 156 and a drawstring 159. The mesh may be, for example, a commercially available 50 mm fishing mesh. In an embodiment the drawstring is a covered elastic cord that is commonly referred to as “bungee” cord. These are examples only, and embodiments are not in any way limited to any particular type or size of flexible mesh or any particular type of drawstring.

The drawstring 159 is releasable to expand an opening 158 defined by the flexible mesh 156 as shown in FIG. 9, and is retractable to tighten the drawstring and constrict the opening as shown in FIG. 5.

When the example lobster trap is submerged to trap lobster, the drawstring 159 is retracted as shown in FIG. 5. The drawstring 159 may be releasably couplable to (attachable to and detachable from, for example) another part of the trap, such as the top, to releasably retain or hold the drawstring (or tension in the drawstring) and constrict the opening 158 as shown in FIG. 5, and release the drawstring (or tension in the drawstring) to expand the opening 158 as shown in FIG. 9. The opening 158 is constricted, which may also be referred to as restricted or closed for example, to prevent lobster from exiting the interior enclosure of the trap 100. A hook, for example, may be especially useful to couple the drawstring 159 to a grid material and enable the drawstring to be quickly released for unloading lobster. Other types of coupling are also possible, including coupling by tying off the drawstring to a part of the trap or to a retention structure such as a cleat on the trap. Embodiments are not in any way restricted to a specific element or component for releasably retaining tension in the drawstring 159 to constrict the opening 158.

In order to avoid further congestion and to more clearly illustrate the opening 158 and the drawstring 159 when the opening is not fully expanded, FIGS. 2 and 5 show the opening constricted but without the drawstring under tension. In the example shown in FIGS. 2 and 5, the drawstring 159 is first pulled downward toward the bottom, or in another direction such as outward from the harvest side, to constrict opening 158 as shown. Then the drawstring can be pulled toward and coupled to the top of the lobster trap such that it is partially looped back over itself when it is to be retained under tension. This is only an example, and the present disclosure is not restricted to any particular sequence or pattern of tensioning, routing, or coupling the drawstring 159.

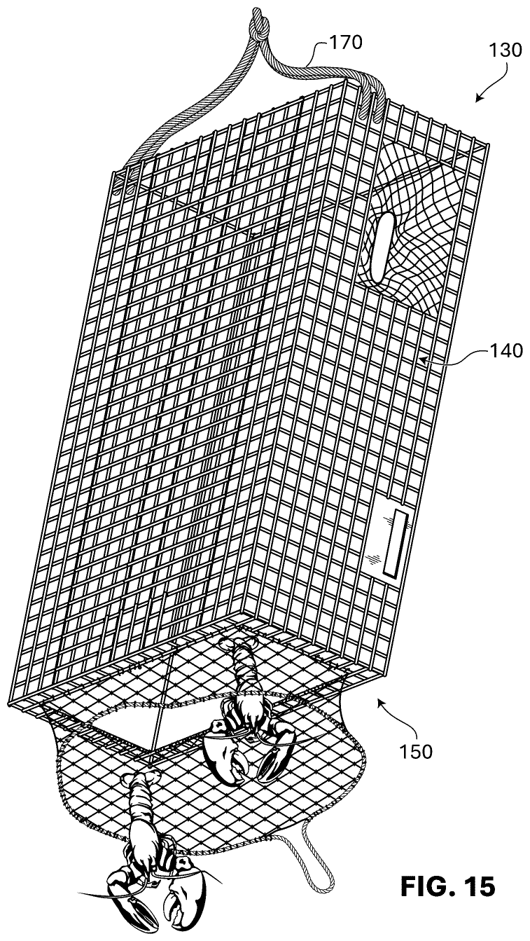

For unloading, the example trap may be suspended as shown in FIG. 15 and discussed in further detail below, with the harvest side 150 in a downward orientation. On release of tension from the drawstring 159, by decoupling the drawstring from another part of the trap for example, the opening expands under the weight of the catch that would be resting on the flexible mesh 156 and will fall out of the trap through the now-expanded opening 158. Expansion of the opening may also be referred to as opening the flexible mesh or releasing the opening, for example.

This type of unloading is much more time-efficient than manual unloading, which can be of significant benefit. Reduced unloading time can reduce delay to a subsequent operation involving a trap, which in turn can reduce vessel operating time and cost and/or increase revenue because traps can be stored or reset more quickly. Reducing either or both of storage time or resetting time can shorten vessel operating time and cost at least in the sense that a vessel may return to port more quickly (to unload catch from a hold for example) after traps are stored or reset. Resetting traps more quickly can increase revenue at least in the sense that traps remain out of the water for less time, and can potentially increase yield within a period of fishing time or require less time to reach a catch quota or other target.

Beyond the potential benefits of faster unloading, a drawstring closure of the type disclosed herein can be advantageous over other possible types of unloading options such as a trap door or top doors in that it provides for simple operation to expand and constrict an opening through which catch can be unloaded. Such a closure also does not add significant weight to a trap, and could potentially reduce trap weight. For example, it is unlikely that the combination of flexible mesh, a drawstring, and a hook or other releasable element for retaining tension in the drawstring will weigh more, or possibly as much as, a trap door or metal-based grid material that may be used for all sides of a trap that is intended for top-door unloading.

In the example lobster trap 100, the harvest side 150 also includes a partial frame 152 (FIG. 5) around a perimeter of the harvest side. The flexible mesh 156 is coupled to the partial frame 152. The flexible mesh 156 may be coupled to ends of the top 110, the bottom 160, the rear side 120 (not labelled in FIG. 5 but at the left in FIG. 5) and the front side 140 (not labelled in FIG. 5 but at the right in FIG. 5) in some embodiments. However, the partial frame 152 may be advantageous in that it provides additional strength to a trap relative to embodiments in which the flexible mesh is coupled directly to ends of the top 110, the bottom 160, and the rear and front sides 140, 120.

For example, such a partial frame 156 may be continuous grid material around the opening 154 and coupled to ends of the top 110, the bottom 160, and the rear and front sides 140, 120, for added structural support against “racking” or movement of the top and bottom relative to each other in the horizontal direction in FIG. 5 and/or the rear and front sides relative to each other in the vertical direction in FIG. 5. Such racking would at least temporarily deform the rectangular trap from a rectangular cross-section into a parallelogram, and may damage the trap or components thereof. For example, racking may deform or damage trap entrances so that they are not as effective in permitting entry into the trap and/or reduce integrity of the internal enclosure and allow lobster to escape.

The partial frame 156 is one grid block wide in the example shown in FIG. 5, and this is just one illustrative example. A wider frame may be used in other embodiments, or a partial frame may have a different structure from other walls of a trap. As an example, a partial frame made of the same grid material as other parts of a trap may be convenient for trap manufacturing, but a solid or tubular partial frame may instead be used in other embodiments. A harvest side as disclosed herein is not restricted to only embodiments that include a partial frame, or to any particular type, size, or structure of a partial frame.

The element 152 is referred to as a “partial” frame in the sense that it forms part of the harvest side, or a partial wall or side of a trap. This partial frame 152 may instead be referred to as a frame, in the sense that it is a complete frame around edges of the opening 154.

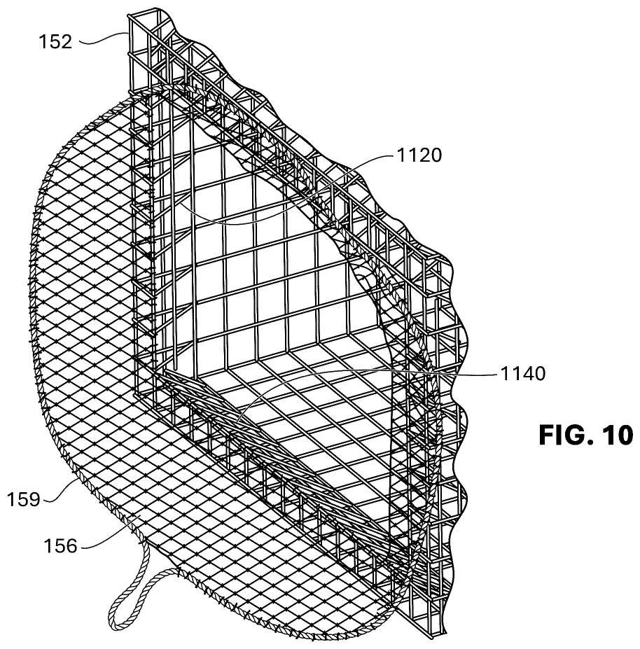

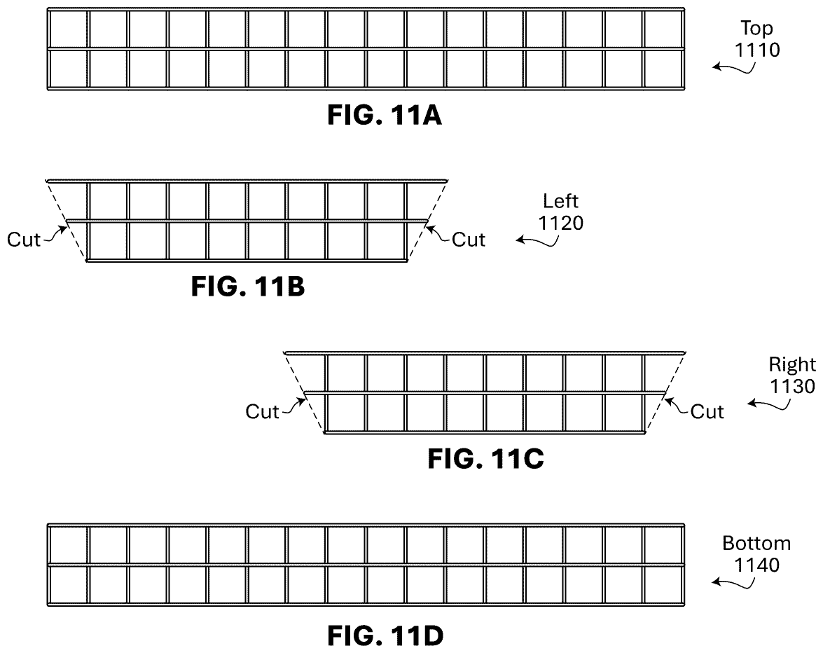

Another optional feature that may be provided in some embodiments relates to tapered walls at the harvest side 150. Such tapered walls are shown most clearly in FIGS. 10 and 11.

FIG. 10 illustrates tapered walls extending from each of the top, the bottom, and the front and rear sides towards the flexible mesh. These tapered walls aid in unloading of lobster from the rectangular enclosure through the opening in the flexible mesh 156 when tension is released from the drawstring 159 and the opening is expanded. There are four tapered walls, and in the view shown in FIG. 10 the tapered wall 1120 at the left and the tapered wall 1140 at the bottom (in the view shown in the drawing) are most clearly visible. Two more tapered walls are at the top and the right in the view shown in FIG. 10, but are not labelled in order to avoid further congestion in the drawing. During unloading of the example lobster trap 100, the trap is suspended with the harvest side 150 oriented downward, and lobster inside the trap fall through the expanded opening 158. The tapered walls help direct the lobster toward opening, further facilitating unloading of catch by potentially reducing the likelihood of lobster becoming entangled in the flexible mesh 156 during unloading.

In some embodiments, the tapered walls include multiple wall sections, as shown by way of example in FIGS. 11A-D. The “Top”, “Left”, “Right”, and “Bottom” labels at 1110, 1120, 1130, 1140 in FIGS. 11A-D refer to the orientation shown in FIGS. 5 and 10. The “Cut” labels in FIGS. 11A-D indicate end edges along which the shorter tapered walls 1120, 1130 (in this example) are cut at an angle that matches a taper angle between the tapered walls and each adjacent wall 1110, 1140, in order to accommodate the longer tapered walls without also cutting the end edges of those longer tapered walls. In other embodiments, the end edges of the long tapered walls may be cut at the taper angle, one end edge of each wall may be cut at the taper angle, or both end edges of all tapered walls may be cut to provide for mitred corners between the tapered walls.

The tapered walls are tapered at least in the sense that they are angled relative to other walls to which they are adjacent, including the top, bottom, front side, rear side, and harvest side (partial frame) in the example shown. Each individual tapered wall may or may not itself be tapered, as shown by way of example in FIGS. 11A-D, in which the shorter tapered walls are cut or individually “tapered”.

In the example shown in FIGS. 10 and 11A-D, the tapered walls are two grid blocks wide. This is an illustrative example, and wider or narrower tapered walls may be used in other embodiments. Tapered walls may also or instead have a different structure from other walls of a trap. Tapered walls as disclosed herein are not restricted to any particular wall type, size, or structure.

Tapered walls need not necessarily be provided as separate wall sections as in the example shown. A four-sided ramp structure, for example, may also provide the same or similar features and functions as the tapered walls that are shown.

As another example, ends of the top 110 and the bottom 160, and ends of the rear and front sides 140 and 120, may be bent toward each other, potentially trimmed to improve fit, and/or potentially coupled to each other, to form tapered walls to which the harvest side is coupled. In this example, the top 110, the bottom 160, and the rear and front sides 140 and 120 may be described as including the tapered walls. In this type of structure, the bent ends may provide benefits of both the partial frame 152 and the tapered walls.

Tapered walls and the partial frame 152 are not mutually exclusive features, as demonstrated by the example lobster trap 110, which includes both tapered walls and the partial frame 152. Therefore, in some embodiments the harvest side 150 includes a partial frame, and a trap also includes tapered walls at the harvest side. In such embodiments, the tapered walls may be coupled to the partial frame 152, and to the top 110, the bottom 160, and the rear and front sides 140 and 120. With the tapered walls coupled in this manner, not only are the tapered walls secured in place to resist movement due to contact with lobster during unloading, but also the tapered walls then structurally reinforce the partial frame 152. The partial frame 152 helps carry the load of the catch weight when the example lobster trap is suspended and the catch is resting on the harvest side, and coupling the tapered walls to the partial frame adds further load support inwardly of outer edges of the partial frame, in effect transferring some of the load to the top 110, the bottom 160, and the rear and front sides 140 and 120. Tapered walls that are coupled to the partial frame 152 and to the top 110, the bottom 160, and the rear and front sides 140 and 120 also provide additional structural rigidity and resistance to racking.

As described briefly above and in more detail below, the example lobster trap is preferably suspended, with the harvest side 150 oriented downward, for unloading.

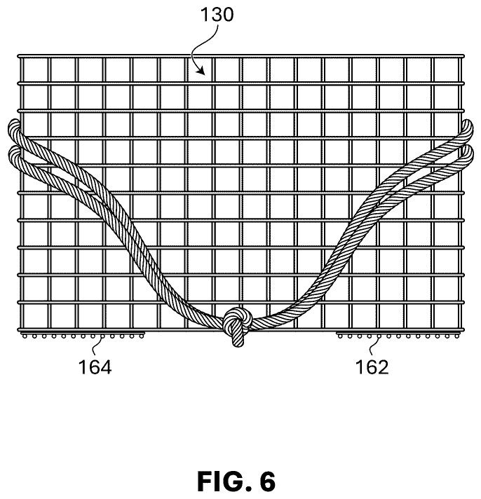

The sides of the example lobster trap 100 also include a side 130, referred to herein as a suspension side, that is opposite the harvest side and is oriented upward when the lobster trap is suspended for unloading. The suspension side is the right side 130 of the example lobster trap in the view shown in FIG. 1, and is also shown in FIG. 6. In the example shown, the suspension side 130 is a panel of grid material. In other embodiments, the suspension side may include other features.

A lobster trap may include a suspension structure, coupled to the trap, to enable the trap to be suspended at the suspension side. A simple example is shown at 170 in FIGS. 1 and 2, as a rope or cord that is coupled (tied in the example shown) to opposite corners of the trap at the suspension side 130. A suspension structure of the type shown by way of example in FIGS. 1 and 2 may be referred to as a bridle or strap, for example, and may be tied to the trap as generally shown in FIGS. 1 and 2. The present disclosure is not restricted to any particular way of coupling a suspension structure to a trap, and the example shown is intended to generally show a tied suspension structure. The specific manner of coupling, including a knot or tying pattern for example, may be different in other embodiments. Although a suspension structure is used to suspend a trap when using the drawstring closure to empty the catch as disclosed herein, it may also be coupled to a back line or buoy line for harvest operations such as trap setting and retrieval.

As shown perhaps most clearly in FIG. 1, the suspension structure 170 need not be coupled only to the suspension side 130, and need not necessarily be coupled to the suspension side at all. In the example shown, with the suspension structure 170 passing through grid openings in the rear side 120 and the front side 140, those sides bear most of the load of the lobster trap 100 when the trap is suspended. The lobster trap 100 may still be described as being suspended “at” the suspension side 130, meaning that the suspension side is oriented upward when the trap is suspended, even though the trap might not necessarily be suspended “from” the suspension side.

Other features may also or instead be provided. For example, in some embodiments a lobster trap may include a weight coupled to the bottom, to bias the lobster trap toward sinking in water bottom first, and with the bottom toward the seabed when the trap is deployed.

Coated metal grills 162, 164 coupled to the bottom 160 are shown in FIGS. 5, 6, and 8 as an example of a weight. The two grills 162, 164 extend partially along the lobster trap 100 in the embodiment shown. The present disclosure is not restricted to any particular type, size, structure, or number of weights. For example, other embodiments may include a single weight element or more than two weight elements, weight elements that extend in a different direction than shown, weight elements that are not in the form of grills, and/or weight elements that are less physically expansive (shorter than shown for example) or more physically expansive (longer than shown to extend the full length of the lobster trap for example). In general, a balanced weight as in the example shown, which is balanced around both central axes of the bottom 160, to help avoid tumbling of the lobster trap 100 and/or the lobster trap landing on its top 110 or one of its sides 120, 130, 140, 150 on the seabed.

In some embodiments, a lobster trap may include one or more internal walls to divide the rectangular enclosure inside the trap into multiple chambers. Each internal wall may include an entrance to permit one-way passage of lobster from one chamber to an adjacent chamber. The entrance in an internal wall may be of the same structure as the entrances 124, 144 in FIGS. 3 and 4, a similar structure, or potentially a different structure. Entrances of the same or similar structure may generally be preferred to streamline manufacturing.

As an example, a first internal wall may be coupled between the top 110 and the bottom 160, and between the rear and front sides 120, 140, adjacent the entrances 124, 144 to form a chamber that may generally be referred to as a “kitchen”. The kitchen carries bait to attract lobster, and lobster first enter the kitchen. The entrance in this internal wall extends and narrows away from the kitchen, and lobster that have entered the kitchen may move through that entrance and into a further chamber that may generally be referred to as a “bedroom” as more lobster are attracted by the bait to enter the kitchen.

In some embodiments, there may be multiple internal walls, such as a second internal wall, substantially parallel to the kitchen/bedroom wall described above, to divide the remainder of the trap enclosure into a first bedroom adjacent the kitchen and a second bedroom toward the harvest side 150. The entrance in the second internal wall extends and narrows away from the first bedroom, and lobster that have entered the first bedroom may move through the second internal wall entrance and into the second bedroom.

In the example with one internal wall, there are two chambers, including the kitchen and the bedroom. In the example with two internal walls, there are three chambers, including the kitchen, the first bedroom, and the second bedroom.

More than two internal walls, and/or internal walls oriented differently than in these examples, may be provided in other embodiments.

In the case of an entrance in an internal wall, an anchor element may be coupled to the entrance and to a next internal wall, or to a side of the trap. In the above example with two internal walls an anchor element (or one at each side of an inner opening of the entrance) of the kitchen/first bedroom wall may be coupled to the second bedroom wall, and an anchor element (or one at each side of an inner opening of the entrance) of the first bedroom/second bedroom wall may be coupled toward an end of the rear side 120 and the front side 140 at the harvest wall 150, or to a part of the harvest wall. This is another potential benefit of the partial frame 152, in that it provides an anchor location for one or more anchor elements coupled to an entrance of an internal wall of the trap. Without the partial frame 152, an internal wall entrance could be coupled toward the harvest side end of the rear side 120 and the front side 140, but this may tend to pull those walls together under tension in the anchor element(s) to hold the entrance in place. The partial frame avoids this by providing available anchor points that are more aligned with an extension direction of such an internal wall entrance.

An internal wall, even with an entrance, impedes movement of lobster within a trap to at least some degree. Considering a kitchen, first bedroom, and second bedroom design as an example, an escape vent 146 (FIG. 3) is normally provided in the second bedroom, which is the internal chamber that is farthest from an entrance. This means that smaller lobster, in order to escape the trap, would have to move from the kitchen, through the first bedroom, and into the second bedroom before being able to escape through the escape vent. From a conservation standpoint, an escape vent positioned closer to an entrance, such as in the kitchen or in the first bedroom in this example, may help reduce by-catch because smaller lobster are able to escape the trap without having to move through internal wall entrances to the second bedroom. Multiple escape vents could be provided, in both bedrooms or in both bedrooms and the kitchen for example, to provide more opportunity for smaller lobster to escape. A differently located escape vent or multiple escape vents may not only potentially help in conservation by reducing by-catch, but also potentially lead to production gain in that less time is needed to sort out smaller lobster when there is less by-catch.

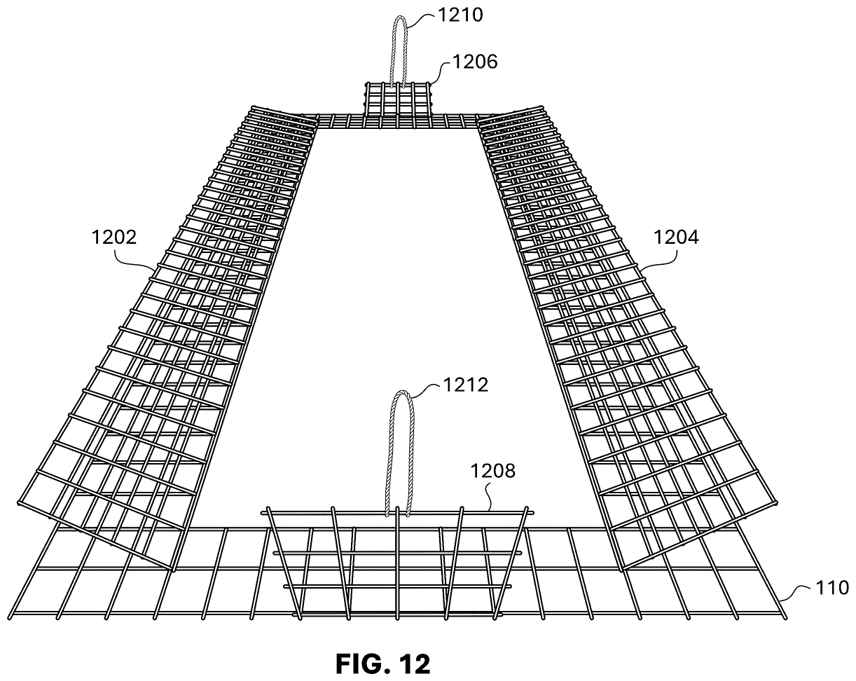

Although a harvest side as disclosed herein provides an option for faster emptying of catch from a lobster trap, one or more doors may still be provided, at a top of a trap for example, to enable baiting, cleaning, repair, or more generally access to the inside enclosed space of a trap. FIG. 12 is a perspective view illustrating doors of the top of the lobster trap of FIG. 1 in open positions. In the example shown, there are two doors 1202, 1204 that extend longitudinally along the top 110 and are coupled to the top 110. Elements 1206, 1208 in FIG. 12 are latches, which are also coupled to the top 110. Loops 1210, 1212 are coupled to the latches 1206, 1208. The doors 1202, 1204 and the latches 1206, 1208 are made from the same material as the top 110 in the example shown. In other embodiments, different materials may be used. The loops 1210, 1212 may be made from string, rope, or cord such as bungee cord referenced elsewhere herein.

In the embodiment shown, the top 110 includes a partial frame around an opening, and the doors 1202, 1204 and the latches 1206, 1208 are coupled to the partial frame. The doors 1202, 1204 and the latches 1206, 1208 are coupled to the partial frame in a manner that allows them to rotate, as if on hinges, relative to the partial frame. Although hinges could be used to couple the doors 1202, 1204 and/or the latches 1206, 1208 to the partial frame, other coupling elements including the examples provided above may be used to couple the doors and/or the latches to the partial frame and still permit rotation of the doors between open and closed positions. The doors 1202, 1204 cover the opening when closed. To close the doors 1202, 1204, the free sides of the doors are moved toward each other, and the doors can be held closed by then rotating the latches 1206, 1208 to partially cover the doors and releasably coupling the loops 1210, 1212 to either or both of the doors or another part of the trap.

The number, shapes, and sizes of the doors 1202, 1204 and the latches 1206, 1208, and the shape and size of the opening, and the size of the partial frame (three grid squares along long edges and two grid squares on short edges) are all examples. Other embodiments may include a single door and a single latch, for example. The doors 1202, 1204 are five grid squares wide to close a ten-grid square wide opening in the example shown, but may instead be sized to partially overlap. Other variations are possible.

Grid material may be preferred for lobster traps of the type disclosed herein, and can be directly coupled together to build a trap. Using the same grid material for all of the primary structure of a trap may simplify construction of a trap. Parts such as walls can then be cut and/or otherwise shaped to preferred size from the same material, and coupled together. A trap may also or instead include a rectangular frame structure. For example, trap walls may be coupled to each other around such a frame structure, or the top, the bottom, and the sides may be coupled only to the rectangular frame structure to form a rectangular enclosure. An internal frame structure may add strength to a trap, but would also increase its cost and weight. These are examples of factors or criteria that trade off against each other in determining trap design.

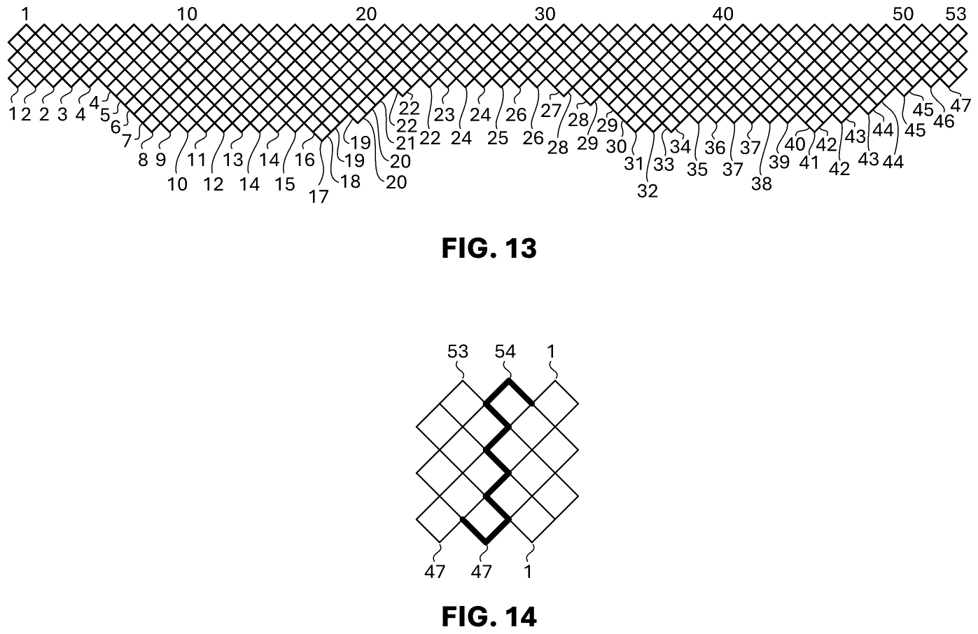

The flexible mesh and opening in a harvest side may similarly be formed in any of various ways. FIG. 13 is a plan view illustrating a pattern of flexible mesh that may be used in an embodiment to define the opening at the harvest side of the example lobster trap 100, and FIG. 14 is a plan view illustrating a seam to couple ends of the flexible mesh in FIG. 15 together to complete the opening.

The numbers at the bottom in FIG. 13 represent a sequence of grid squares beginning at the left of the top middle of the partial frame 152 in FIG. 5 and traversing counter-clockwise around the partial frame. The bottom grid square numbers indicate the grid square to which each indicated part of the flexible mesh is to be coupled in the example shown. The upper numbers indicate the sequence of mesh points along the top part of the mesh. The upper and lower numbers in FIG. 13 do not align in the example shown, because the starting points are different, and there are several instances of multiple lower mesh parts having the same indicated grid square indicator.

With reference also to FIG. 9, in order to define the opening 158 in the harvest side 150, the mesh parts at the bottom in FIG. 13 are coupled to the indicated grid squares, and the opening is completed with a seam as shown in FIG. 14. The seam may be hand-tied or otherwise made to couple ends of the mesh in FIG. 13 together. The drawstring is weaved through the mesh inside the mesh points that are shown at the top in FIG. 13.

The mesh pattern shown in FIG. 13, and the seam in FIG. 14 are examples that have been found to work well to enable the opening at the harvest end to be constricted for holding catch and released for emptying the catch, for a trap having a partial frame with the number of grid squares indicated at the bottom of FIG. 13. Other mesh patterns and/or seam patterns may be used in other embodiments.

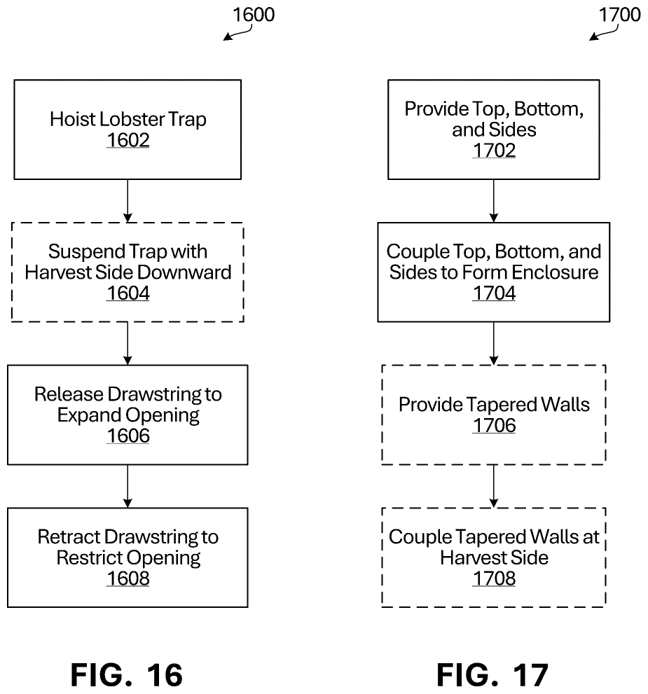

FIG. 15 illustrates the lobster trap of FIG. 1 in a suspended position, and will be referenced in the context of an example method that is illustrated in FIG. 16. In the suspended position, the harvest side 150 is oriented downward, and the suspension side 130 is oriented upward. As illustrated in FIG. 15, the lobster trap need not be oriented vertically, and the sides 130, 150 need not be oriented horizontally for lobsters to fall through the expanded opening in the harvest side 150 when the lobster trap is suspended. In other words, the harvest side 150 may be oriented downward without being oriented perfectly horizontally to allow lobster to fall perfectly vertically through the expanded opening in the flexible mesh. With the suspension structure 170 coupled to the trap as shown in FIG. 15, the trap will be suspended substantially vertically, but at an angle from perfectly vertical. The angle of suspension will depend on such factors as suspension geometry and weight distribution, but it has been found that this angle for a trap with catch inside tended to be within plus or minus 22.5 degrees from vertical.

The description above, and FIGS. 1 to 15, focus primarily on embodiments of a lobster trap. Other embodiments, including method embodiments, are also contemplated.

For example, a method 1600 for harvesting lobster is shown in FIG. 16, and may involve hoisting or otherwise removing a lobster trap from water at 1602. This may also be referred to as hauling the trap, for example. The hoisting at 1602 may involve, for example, using a crane and block on board a fishing vessel. The lobster trap may be consistent with any embodiment herein, including a top, a bottom, and sides coupled together to form a rectangular enclosure, with the sides including an entrance side, an escape side, and a harvest side. Such a method may also involve suspending the lobster trap with the harvest side oriented downward. Although such suspending shown separately at 1604, the suspending may naturally result from the hoisting. For example, when a trap has been hoisted out of the water, it may remain suspended with the harvest side oriented downward, as shown by way of example in FIG. 15, when the hoisting is complete. The lobster trap may be suspended in this orientation when hoisted out of the water, and may be moved from an over-water position to a position over the deck of a vessel for emptying the catch while the trap remains suspended.

With the lobster trap suspended, a next operation may involve releasing the drawstring as shown at 1606, to expand the opening in the harvest side and allow lobster that are inside the lobster trap to fall out of the lobster trap through the opening.

After the lobster have fallen out of the lobster trap, a next operation may involve retracting the drawstring to constrict the opening, as shown at 1608.

In some embodiments, as described in further detail at least above, the drawstring is attachable to and detachable from the lobster trap. In such an embodiment, releasing the drawstring at 1606 may involve detaching the drawstring from the lobster trap to release tension to the drawstring and expand the opening, and retracting the drawstring at 1608 may involve attaching the drawstring to the lobster trap to apply tension to the drawstring and constrict the opening.

Other lobster trap features are disclosed herein and may be provided. In some embodiments, counterpart method operations may be performed to make use of such features.

Another example method is illustrated in FIG. 17. The example method 1700 relates to manufacturing a lobster trap.

As shown, such a method 1700 may involve providing a top, a bottom, and sides as shown at 1702. Providing these components, and/or others, may involve making the components, purchasing or otherwise sourcing the components, or making the components available for use. Therefore, providing may involve, but is not limited to, making components that are provided.

As in other embodiments, the sides include an entrance side, an escape side, and a harvest side.

Such a method may also involve coupling the top, the bottom, and the sides to form a rectangular enclosure, as shown at 1704.

Other features disclosed herein may also be embodied in such a method.

For example, providing the harvest side at 1702 may involve providing a partial frame around a perimeter of the harvest side, in which case the flexible mesh of the harvest side would be coupled to the partial frame. A method may also involve coupling the flexible mesh to the partial frame.

As another example, a method may involve providing tapered walls as shown at 1706, and coupling the tapered walls at the harvest side as shown at 1708. Coupling the tapered walls at the harvest side may involve coupling the tapered walls to the top, the bottom, and rear and front sides of a trap, for example. The tapered walls extend towards the flexible mesh to aid in unloading of lobster from the rectangular enclosure through the opening.

In embodiments that also include a partial frame, a method may involve coupling the tapered walls to the partial frame as well, at 1708 for example.

Other features disclosed herein may also or instead be provided, supported, and/or used in method embodiments. The following are non-limiting examples, any of which may be implemented, alone or in any combination, in some embodiments:
the drawstring may be attachable to the lobster trap to retain tension in the drawstring and detachable from the lobster trap to release tension from the drawstring, in which case:
   such a drawstring may be used at 1606 and/or 1608 in FIG. 16;
   providing the harvest side, at 1702 in FIG. 17 for example, may involve providing the harvest side with the drawstring being attachable to the lobster trap to retain tension in the drawstring and detachable from the lobster trap to release tension from the drawstring;
the sides of the trap may include a suspension side, opposite the harvest side, and the trap may also include a suspension structure, coupled to the lobster trap, to enable the lobster trap to be suspended at the suspension side, in which case:
   the hoisting, at 1602 in FIG. 16 for example, may involve hoisting the trap using the suspension structure;
   the suspending, at 1604 in FIG. 16 for example, may involve suspending the trap at the suspension side from the suspension structure;
   the providing, at 1702 in FIG. 17 for example, may involve providing a suspension side;
   the coupling, at 1704 in FIG. 17 for example, may involve coupling a suspension side opposite the harvest side, to the top, the bottom, and front and rear sides of the trap for example;
   a method may involve providing a suspension structure, and coupling the suspension structure to the lobster trap, to enable the lobster trap to be suspended at the suspension side;
the entrance side and the escape side may be the same side, in which case the providing, at 1702 for example, may involve providing a side that includes both the entrance and the escape vent;
the lobster trap may include a rectangular frame structure, in which case:
   a method may involve providing the rectangular frame structure;
   the coupling, at 1704 for example, may involve coupling the top, the bottom, and the sides to the rectangular frame structure to form the rectangular enclosure;
the lobster trap may include a weight coupled to the bottom to bias the lobster trap toward sinking bottom first, in which case:
   a method may involve providing a weight;
   a method may involve coupling the weight to the bottom of the lobster trap;
   the providing, at 1702 in FIG. 17 for example, may involve providing the bottom with a weight coupled thereto;
the lobster trap may include an internal entrance side (or more generally one or more internal entrance sides) to divide the rectangular enclosure into two chambers (or more generally one or more chambers), in which case:
   a method may involve providing an internal entrance side (or more generally one or more internal entrance sides);
   a method may involve coupling an internal entrance side (or more generally each of one or more internal entrance sides) inside the rectangular enclosure, to the top, the bottom, and front and rear sides for example, to divide the rectangular enclosure into two chambers (or more generally one or more chambers);
the lobster trap may include an anchor element, coupled to the entrance, to maintain inward extension of the entrance into the rectangular enclosure, in which case:
   a method may involve providing an anchor element;
   the providing, at 1702 in FIG. 17 for example, may involve providing the entrance side with an anchor element coupled to the entrance;
   a method may involve coupling an anchor element to the entrance, to maintain inward extension of the entrance into the rectangular enclosure;
   the coupling, at 1704 in FIG. 17 for example, may involve coupling an anchor element to the entrance, to maintain inward extension of the entrance into the rectangular enclosure.

More generally, features disclosed herein in the context of any particular embodiment, such as a lobster trap embodiment or a method embodiment, may also or instead be provided in other embodiments.

What has been described is merely illustrative of the application of principles of embodiments of the invention. Other arrangements and methods can be implemented by those skilled in the art without departing from the scope of the present invention.

For example, the drawings are intended solely for illustrative purposes. Other embodiments might include further, fewer, or additional features, arranged in a similar or different manner than shown.

1. A lobster trap comprising:
a top, a bottom, and sides coupled together to form a rectangular enclosure;
the top comprising:
a door to enable access inside the rectangular enclosure;
the sides comprising:
an entrance side, the entrance side comprising an entrance that extends and narrows inwardly into the rectangular enclosure to permit entry of lobster into the rectangular enclosure;
an escape side, the escape side comprising an escape vent to allow lobster smaller than a minimum size to escape the rectangular enclosure;
a harvest side, the harvest side comprising a flexible mesh and a drawstring, wherein the drawstring is releasable to expand an opening defined by the flexible mesh and is retractable to tighten the drawstring and constrict the opening.

2. The lobster trap of claim 1, wherein the harvest side further comprises:
a partial frame coupled to the top, the bottom, and adjacent sides that are adjacent the harvest side, the partial frame forming part of the harvest side around a perimeter of the harvest side and a complete frame around edges of the opening, the flexible mesh being coupled to the partial frame.

3. The lobster trap of claim 1, further comprising:
tapered walls at the harvest side, the tapered walls extending, at a taper angle from the top, the bottom, and adjacent sides that are adjacent the harvest side, towards the flexible mesh to aid in unloading of lobster from the rectangular enclosure through the opening.

4. The lobster trap of claim 2, further comprising:
tapered walls at the harvest side, the tapered walls extending, at a taper angle from the top, the bottom, and the adjacent sides, to the edges of the opening and the flexible mesh to aid in unloading of lobster from the rectangular enclosure through the opening.

5. The lobster trap of claim 4, wherein the tapered walls are coupled to the partial frame.

6. The lobster trap of claim 1, wherein the drawstring is attachable to the lobster trap to retain tension in the drawstring and detachable from the lobster trap to release tension from the drawstring.

7. The lobster trap of claim 1, wherein the sides further comprise:
a suspension side, opposite the harvest side,
the lobster trap further comprising:
a suspension structure, coupled to the lobster trap, to enable the lobster trap to be suspended at the suspension side.

8. The lobster trap of claim 1, wherein the entrance side and the escape side are the same side comprising both the entrance and the escape vent.

9. The lobster trap of claim 1, further comprising:
a rectangular frame structure, wherein the top, the bottom, and the sides are coupled to the rectangular frame structure to form the rectangular enclosure.

10. The lobster trap of claim 1, further comprising:
a weight coupled to the bottom to bias the lobster trap toward sinking bottom first.

11. The lobster trap of claim 1, further comprising:
an internal entrance side to divide the rectangular enclosure into two chambers.

12. The lobster trap of claim 1, further comprising:
an anchor element, coupled to the entrance, to maintain inward extension of the entrance into the rectangular enclosure.

13. A method for harvesting lobster, the method comprising:
hoisting a lobster trap from water, the lobster trap comprising a top, a bottom, and sides coupled together to form a rectangular enclosure, the top comprising a door to enable access inside the rectangular enclosure, the sides comprising: an entrance side, the entrance side comprising an entrance that extends and narrows inwardly into the rectangular enclosure to permit entry of lobster into the rectangular enclosure; an escape side, the escape side comprising an escape vent to allow lobster smaller than a minimum size to escape the rectangular enclosure;
and a harvest side, the harvest side comprising a flexible mesh and a drawstring, wherein the drawstring is releasable to expand an opening defined by the flexible mesh and is retractable to tighten the drawstring and constrict the opening;
suspending the lobster trap with the harvest side oriented downward;
releasing the drawstring to expand the opening and allow lobster inside the lobster trap to fall out of the lobster trap through the opening;
retracting the drawstring to constrict the opening.

14. The method of claim 13, wherein the drawstring is attachable to and detachable from the lobster trap, the releasing comprising:
detaching the drawstring from the lobster trap to release tension to the drawstring and expand the opening.

15. The method of claim 13, wherein the drawstring is attachable to and detachable from the lobster trap, the retracting comprising:
attaching the drawstring to the lobster trap to apply tension to the drawstring and constrict the opening.

16. A method of manufacturing a lobster trap, the method comprising:
providing a top, a bottom, and sides;
the top comprising:
a door to enable access inside the rectangular enclosure;
the sides comprising:
an entrance side, the entrance side comprising an entrance that extends and narrows;
an escape side, the escape side comprising an escape vent to allow lobster smaller than a minimum size to pass through the escape vent;
a harvest side, the harvest side comprising a flexible mesh and a drawstring, wherein the drawstring is releasable to expand an opening defined by the flexible mesh and is retractable to tighten the drawstring and constrict the opening;
the method further comprising:
coupling the top, the bottom, and the sides to form a rectangular enclosure.

17. The method of claim 16, wherein providing the harvest side further comprises:
providing a partial frame coupled to the top, the bottom, and adjacent sides that are adjacent the harvest side, the partial frame forming part of the harvest side around a perimeter of the harvest side and a complete frame around edges of the opening, the flexible mesh being coupled to the partial frame.

18. The method of claim 16, further comprising:
providing tapered walls;
coupling the tapered walls at the harvest side, the tapered walls extending, at a taper angle from the top, the bottom, and adjacent sides that are adjacent the harvest side, towards the flexible mesh to aid in unloading of lobster from the rectangular enclosure through the opening.

19. The method of claim 17, further comprising:
providing tapered walls;
coupling the tapered walls at the harvest side, the tapered walls extending, at a taper angle from the top, the bottom, and the adjacent sides, to the edges of the opening and the flexible mesh to aid in unloading of lobster from the rectangular enclosure through the opening.

20. The method of claim 19, wherein coupling further comprises:
coupling the tapered walls to the partial frame.
